(19) United States
(12) Patent Application Publication
(10) Pub. No.: US 2017/0019953 A1
(43) Pub. Date: Jan. 19, 2017

(54) ELECTRICAL HEATING DEVICE AND ELECTRICAL HEATING METHOD

(71) Applicant: Toyota Jidosha Kabushiki Kaisha, Toyota-shi (JP)

(72) Inventors: Hisanori NAKAMURA, Toyota-shi (JP); Asahiko HASEBE, Miyoshi-shi (JP); Maho KIMURA, Toyota-shi (JP); Takashi SAKUI, Nagoya-shi (JP); Kenichi MORITA, Toyota-shi (JP)

(73) Assignee: Toyota Jidosha Kabushiki Kaisha, Toyota-shi (JP)

(21) Appl. No.: 15/177,450

(22) Filed: Jun. 9, 2016

(30) Foreign Application Priority Data
Jul. 17, 2015 (JP) 2015-143089

(51) Int. Cl. H05B 3/02; H05B 1/02; H05B 3/00

(52) U.S. Cl. CPC H05B 3/023; H05B 3/0004; H05B 1/0294

(57) ABSTRACT

An electrical heating device includes supplemental heating means for supplementarily heating each of areas defined in advance in the material to be heated, and control means. A supplemental heating quantity for each of the areas is obtained by calculating a necessary heating quantity for heating each of the areas to a predefined target temperature and an electrical heating quantity generated in each of the areas by the electrical heating based on cross-sectional area information on the material to be heated and temperature information on the material to be heated and subtracting the calculated electrical heating quantity from the calculated necessary heating quantity. The control means controls, in addition to the control of an electrical heating, the supplemental heating means so that each of the areas is supplementarily heated based on the obtained supplemental heating quantity for each of the areas.

### INCORPORATION BY REFERENCE

This application is based upon and claims the benefit of priority from Japanese patent application No. 2015-143089, filed on Jul. 17, 2015, the disclosure of which is incorporated herein in its entirety by reference.

### BACKGROUND OF THE INVENTION

1. Field of the Invention The present invention relates to an electrical heating device and an electrical heating method for electrically heating a material to be heated.

2. Description of Related Art

An electrical heating device that electrically heats a material to be heated by bringing a pair of electrodes into contact with the material to be heated with a predetermined distance between the electrodes and supplying an electric current flowing between the electrodes has been known (see, for example, Japanese Unexamined Patent Application Publication No. 2014-031566). This electrical heating device reduces a temperature irregularity during its electrical heating process by adjusting an electrical heating time for each area of the material to be heated according to the cross-sectional area (i.e., the cross-sectional dimension) of the material to be heated while moving the pair of electrodes and changing the distance between the electrodes.

The present inventors have found the following problem. In the aforementioned electrical heating device, when the electrodes approach an area having a large cross-sectional area (i.e., a large cross-sectional dimension), the moving speed of the electrodes is reduced in order to increase the heating quantity. Therefore, there is a possibility that the heating time for the material to be heated could increase.

### SUMMARY OF THE INVENTION

The present invention has been made to solve the above-described problem and a main object is to provide an electrical heating device and an electrical heating method capable of reducing the heating time for a material to be heated by performing necessary supplemental heating simultaneously with the electrical heating while considering information about the cross-sectional area of the material to be heated without moving the electrodes.

To achieve the above-described object, a first exemplary aspect of the present invention is an electrical heating device that electrically heats a material to be heated by bringing a plurality of electrodes into contact with the material to be heated with a predetermined distance between the electrodes and supplying an electric current flowing between the electrodes, including: supplemental heating means for supplementarily heating each of a plurality of areas defined in advance in the material to be heated; and control means for controlling the electrical heating and the supplemental heating for the material to be heated, in which a supplemental heating quantity for each of the plurality of areas is obtained by calculating a necessary heating quantity necessary for heating each of the plurality of areas to a predefined target temperature and an electrical heating quantity generated in each of the plurality of areas by the electrical heating based on cross-sectional area information on the material to be heated and temperature information on the material to be heated and subtracting the calculated electrical heating quantity from the calculated necessary heating quantity, and the control means controls, in addition to the control of the electrical heating, the supplemental heating means so that each of the plurality of areas is supplementarily heated based on the obtained supplemental heating quantity for each of the plurality of areas.

In this aspect, the electrical heating device may further include temperature detection means for detecting temperature information on the material to be heated, and when a temperature of the material to be heated detected by the temperature detection means reaches the target temperature of the material to be heated, the control means may stop the electrical heating.

In this aspect, the control means may control the supplemental heating means so as to supplementarily heat only an area of the material to be heated for which the calculated supplemental heating quantity is equal to or larger than a predetermined threshold with the calculated supplemental heating quantity.

To achieve the above-described object, another exemplary aspect of the present invention may be an electrical heating method for electrically heating a material to be heated by bringing a plurality of electrodes into contact with the material to be heated with a predetermined distance between the electrodes and supplying an electric current flowing between the electrodes, including: a step of calculating a necessary heating quantity necessary for heating a plurality of areas defined in advance in the material to be heated to a predefined target temperature and an electrical heating quantity generated in each of the plurality of areas by the electrical heating based on cross-sectional area information on the material to be heated and temperature information on the material to be heated; a step of calculating a supplemental heating quantity for each of the plurality of areas by subtracting the calculated electrical heating quantity from the calculated necessary heating quantity; and a step of controlling, in addition to the control of the electrical heating, supplemental heating for each of the plurality of areas based on the calculated supplemental heating quantity for each of the plurality of areas.

According to the present invention, it is possible to provide an electrical heating device and an electrical heating method capable of reducing the heating time for a material to be heated by performing necessary supplemental heating simultaneously with the electrical heating with consideration given to information about the cross-sectional area of the material to be heated without moving the electrodes.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram showing a schematic system configuration of an electrical heating device according to an exemplary embodiment of the present invention;

FIG. 2 is a figure for explaining a supplementarily-heating method in a case where the cross-sectional area of a material to be heated gradually increases from a positive electrode side toward a negative electrode side;

FIG. 3 is a figure for explaining a supplementarily-heating method in a case where the cross-sectional area of a material to be heated gradually increases from a positive electrode side to the center of the material to be heated and gradually decreases from the center toward a negative electrode side; and

FIG. 4 is a flowchart showing an example of a process flow of an electrical heating method according to an exemplary embodiment of the present invention.

### DESCRIPTION OF THE EXEMPLARY EMBODIMENTS

Exemplary embodiments according to the present invention are explained hereinafter with reference to the drawings. For example, an electrical heating device according to an exemplary embodiment of the present invention heat-treats a material to be heated such as a plate-like metal material (such as a structure for an automobile) by supplying electricity to the material to be heated and thereby directly heating the material to be heated.

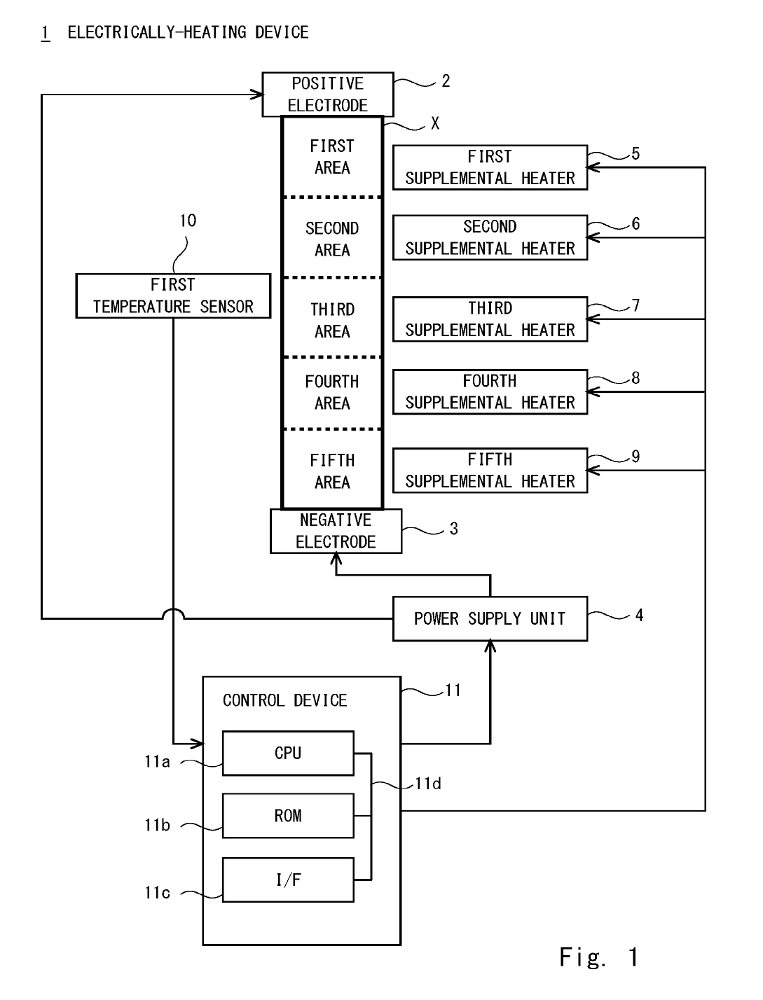

FIG. 1 is a block diagram showing a schematic system configuration of an electrical heating device according to this exemplary embodiment. The electrical heating device 1 according to this exemplary embodiment includes a pair of positive and negative electrodes 2 and 3, a power supply unit 4 that supplies power to the positive and negative electrodes 2 and 3, first to fifth supplemental heaters 5 to 9 each of which heats a respective one of a plurality of areas of a material to be heated X, a temperature sensor 10 that detects the temperature of the material to be heated X, and a control device 11 that controls the power supply unit 4 and the first to fifth supplemental heaters 5 to 9.

The positive and negative electrodes 2 and 3 are brought into contact with the plate-like material to be heated X with a predetermined distance between the positive and negative electrodes 2 and 3. Note that although the pair of positive and negative electrodes 2 and 3 is provided in this exemplary embodiment, the present invention is not limited to such a configuration. For example, two pairs or more than two pairs of positive and negative electrodes 2 and 3 may be disposed. Further, the shape of the material to be heated X is not limited to the plate-like shape. For example, the material to be heated X may have a column shape or a rectangular-column shape.

The power supply unit 4 electrically heats the material to be heated X by supplying an electric current flowing between the positive and negative electrodes 2 and 3. For example, the power supply unit 4 is formed by a power supply such as a battery.

The first to fifth supplemental heaters 5 to 9 are a specific example of the supplemental heating means. The first to fifth supplemental heaters 5 to 9 heat respective predetermined areas of the material to be heated X. Each of the first to fifth supplemental heaters 5 to 9 is, for example, a near-infrared heater or a far-infrared heater.

For example, the first to fifth supplemental heaters 5 to 9 are arranged along the longitudinal direction of the material to be heated X. For example, in the material to be heated X, first to fifth areas are defined in order at regular intervals from the left side (upper side in FIG. 1) of the material to be heated X along its longitudinal direction. The first to fifth supplemental heaters 5 to 9 are disposed in places corresponding to the first to fifth areas, respectively, of the material to be heated X. Further, the first to fifth supplemental heaters 5 to 9 heat the first to fifth areas, respectively, of the material to be heated X. The first to fifth supplemental heaters 5 to 9 heat the first to fifth areas, respectively, of the material to be heated X according to a control signal from the control device 11.

Note that the above-described definition of each area of the material to be heated X is merely an example. The definition of areas is not limited to such an example and can be arbitrarily determined. The number and arrangement of supplemental heaters may be arbitrarily determined, provided that each of the defined areas of the material to be heated X can be appropriately heated. By increasing the number of supplemental heaters, low-temperature areas of the material to be heated X can be heated in a more detailed manner, thus making it possible to reduce the temperature irregularity with higher accuracy. Further, a configuration in which one supplemental heater is moved to and heats each area of the material to be heated X by using a moving mechanism such as a rail mechanism may be adopted. Although the first to fifth supplemental heaters 5 to 9 are heaters of the same type, they may not necessarily be heaters of the same type. The first to fifth supplemental heaters 5 to 9 may be a combination of different types of heaters. For example, optimal supplemental heaters may be disposed for the first to fifth areas with consideration given to the material characteristic of the first to fifth areas.

The temperature sensor 10 detects the temperature of the material to be heated X and outputs the detected temperature to the control device 11. The temperature sensor 10 is, for example, a radiation thermometer. Note that the electrical heating device 1 may not include any temperature sensor 10. In such a case, the current temperature of the material to be heated X may be input to the control device 11 prior to the electrical heating process.

The control device 11 is a specific example of the control means. The control device 11 controls the power supply unit 4 and the first to fifth supplemental heaters 5 to 9. The control device 11 electrically heats the material to be heated X by controlling the power supply unit 4 and thereby controlling the electric current flowing between the positive and negative electrodes 2 and 3. The control device 11 supplementarily heats each of the first to fifth areas of the material to be heated X by controlling first to fifth supplemental heaters 5 to 9 based on information about the cross-sectional area (i.e., the cross-sectional dimension) of the material to be heated X.

For example, the control apparatus 11 may be formed by hardware mainly using a microcomputer including a CPU (Central Processing Unit) 11a that performs control processing, arithmetic processing, and so on, a memory 11b including a ROM (Read Only Memory) and/or a RANI (Random Access Memory) that stores a control program, an arithmetic program, and so on to be executed by the CPU 11a, and an interface unit (I/F) 11c that externally receives and outputs signals. The CPU 11a, the memory 11b, and the interface unit 11c are connected to each other through a data bus 11d or the like.

Incidentally, the related art electrical heating device adjusts an electrical heating time for each area of the material to be heated according to the cross-sectional area of the material to be heated while moving a pair of electrodes and changing a distance between the electrodes. Then, in the electrical heating device, when the electrodes approach an area having a large cross-sectional area, the moving speed of the electrodes is reduced in order to increase the heating quantity. Therefore, there is a possibility that the heating time for the material to be heated could increase.

In contrast to this, in the electrical heating device 1 according to this exemplary embodiment, the control device 11 calculates necessary heating quantities necessary for heating the first to fifth areas to a predefined target temperature and electrical heating quantities generated in the first to fifth areas by the electrical heating based on the cross-sectional area information on the material to be heated X and temperature information on the material to be heated X. Then, the control device 11 calculates supplemental heating quantities for the first to fifth areas by subtracting the calculated electrical heating quantities from the calculated necessary heating quantities. The control device 11 controls, in addition to the control of the electrical heating, the first to fifth supplemental heaters 5 to 9 so that the first to fifth areas are supplementarily heated based on the calculated supplemental heating quantities for the first to fifth areas.

In this way, for each of the first to fifth areas of the material to be heated X, a heat quantity by which the quantity of the heat generated by the electrical heating alone is insufficient to raise the temperature of that area (i.e., a respective one of the first to fifth areas) to the target temperature is calculated by using the cross-sectional area information on the material to be heated X. Then, the calculated heat quantities can be provided to the first to fifth areas in a concentrated manner by using the first to fifth supplemental heaters 5 to 9. That is, it is possible to reduce the heating time for the material to be heated X by performing necessary supplemental heating simultaneously with the electrical heating with consideration given to the cross-sectional area information on the material to be heated X without moving the electrodes while rectifying the temperature irregularity of the material to be heated X.

Note that in the electrical heating device 1 according to this exemplary embodiment, even when the electrodes are moved, an area having a large cross-sectional area is still supplementarily heated by the supplemental heater. Therefore, it is unnecessary to reduce the moving speed of the electrodes in or near the area having a large cross-sectional area, or it is possible to reduce or control the decrease in the moving speed, thus making it possible to reduce the heating time for the material to be heated X.

For example, the width of the material to be heated X is measured by using a laser sensor. The top/bottom parts of the material to be heated X are sandwiched by a pair of displacement gauges and the thickness of the material to be heated X is measured. Then, the cross-sectional area of the material to be heated X is calculated by multiplying the measured width by the thickness of the material to be heated X. The cross-sectional area of the material to be heated X is successively measured at a plurality of places along the longitudinal direction of the material to be heated X and the calculated data is used as the cross-sectional area information on the material to be heated X.

Prior to the electrical heating process, the cross-sectional area information on the material to be heated is input to the control device 11 and stored in the memory 11b. The cross-sectional area information may be stored in the memory 11b in advance. The control device 11 may calculate the cross-sectional area information on the material to be heated X based on the above-described values measured by the laser sensor and the displacement gauges.

The control device 11 calculates, for each of the first to fifth areas, a necessary heating quantity necessary for heating that area (i.e., a respective one of the first to fifth areas) to the predefined target temperature based on the cross-sectional area information on the material to be heated X and the temperature of the material to be heated X. The aforementioned target temperature is set, for example, in the memory 11b in advance.

For example, the control device 11 calculates the temperature increase by which the temperature of the material to be heated X should be raised based on the temperature of the material to be heated X and the set target temperature. The control device 11 calculates a necessary heat quantity for each of the first to fifth areas based on the calculated temperature increase and a correlation between the cross-sectional area of that area (i.e., a respective one of the first to fifth areas) (such as an average cross-sectional area or a cross-sectional area at the center of that area) and a heat quantity per unit temperature increase (i.e., a heat quantity necessary for raising the temperature of that area by unit temperature). Note that the aforementioned correlation between the cross-sectional area and the heat quantity can be experimentally calculated in advance with consideration given to the material characteristic of the material to be heated X and the like.

The control device 11 calculates electrical heating quantities generated in the first to fifth areas by the electrical heating based on the cross-sectional area information on the material to be heated X. For example, the control device 11 calculates the electrical heating quantities of the first to fifth areas based on the cross-sectional areas of the first to fifth areas (such as average cross-sectional areas or cross-sectional areas at the centers of the respective areas) and the correlations between the cross-sectional areas of the first to fifth areas and their electrical heating quantities. Note that the aforementioned correlation between the cross-sectional areas and the electrical heating quantities can be experimentally calculated in advance with consideration given to the material characteristic of the material to be heated X and the like.

The control device 11 calculates the supplemental heating quantities of the first to fifth areas by subtracting the electrical heating quantities from the above-described calculated necessary heating quantities. Further, the control device 11 controls the first to fifth supplemental heaters 5 to 9 so as to provide the calculated supplemental heating quantities for the first to fifth areas to the first to fifth areas, respectively. Note that although the control device 11 calculates the supplemental heating quantities for the first to fifth areas, the present invention is not limited to such a configuration. The supplemental heating quantities may be calculated and input to the control device 11 by a user in advance.

For example, the control device 11 controls the heating for the first to fifth areas of the material to be heated X by controlling the heating time of the first to fifth supplemental heaters 5 to 9 while maintaining their heating output at a constant level.

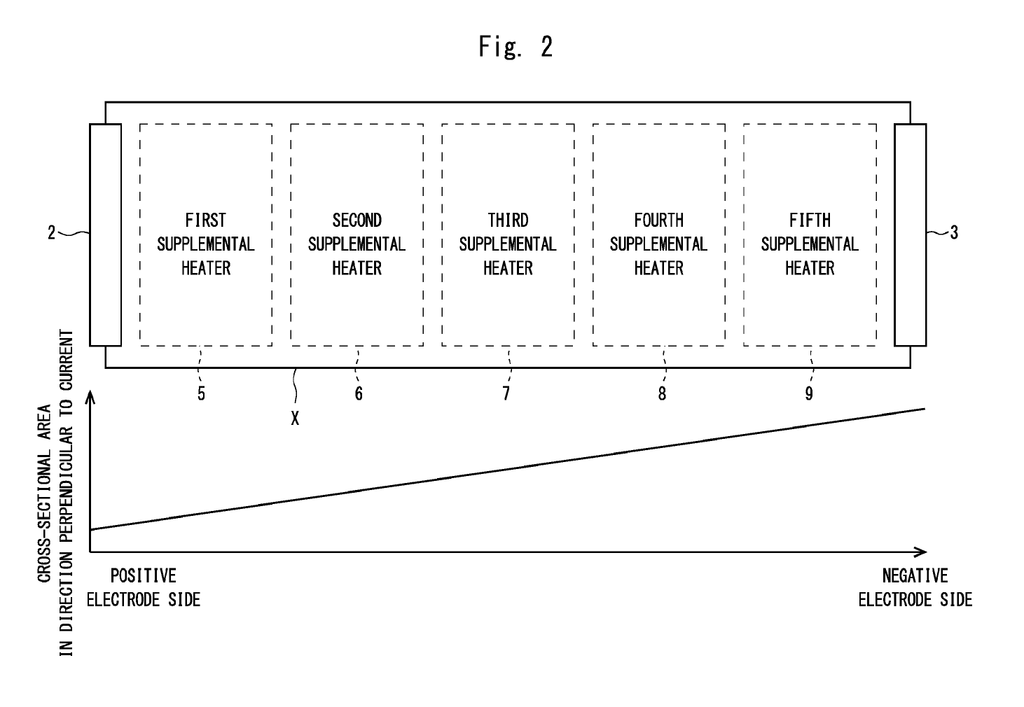

For example, assume a case where the cross-sectional area of a material to be heated gradually increases from the positive electrode side toward the negative electrode side as shown in FIG. 2. In this case, the supplemental heating quantities of the first to fifth areas change in such a manner that the supplemental heating quantity increases from the first area on the positive electrode 2 side toward the fifth area on the negative electrode 3 side.

((supplemental heating quantity for first area)<(supplemental heating quantity for second area)<(supplemental heating quantity for third area)<(supplemental heating quantity for fourth area)<(supplemental heating quantity for fifth area))

To cope with this, the control device 11 increases the heating time for the first to fifth supplemental heaters 5 to 9 from the first supplemental heater 5 toward the fifth supplemental heater 9 since the supplemental heating quantity increases from the positive electrode 2 side toward the negative electrode 3 side. For example, the control device 11 sets the heating time of the first supplemental heater 5 to 0 seconds, the heating time of the second supplemental heater 6 to 1 second, the heating time of the third supplemental heater 7 to 2 seconds, the heating time of the fourth supplemental heater 8 to 3 seconds, and the heating time of the fifth supplemental heater 9 to 4 seconds.

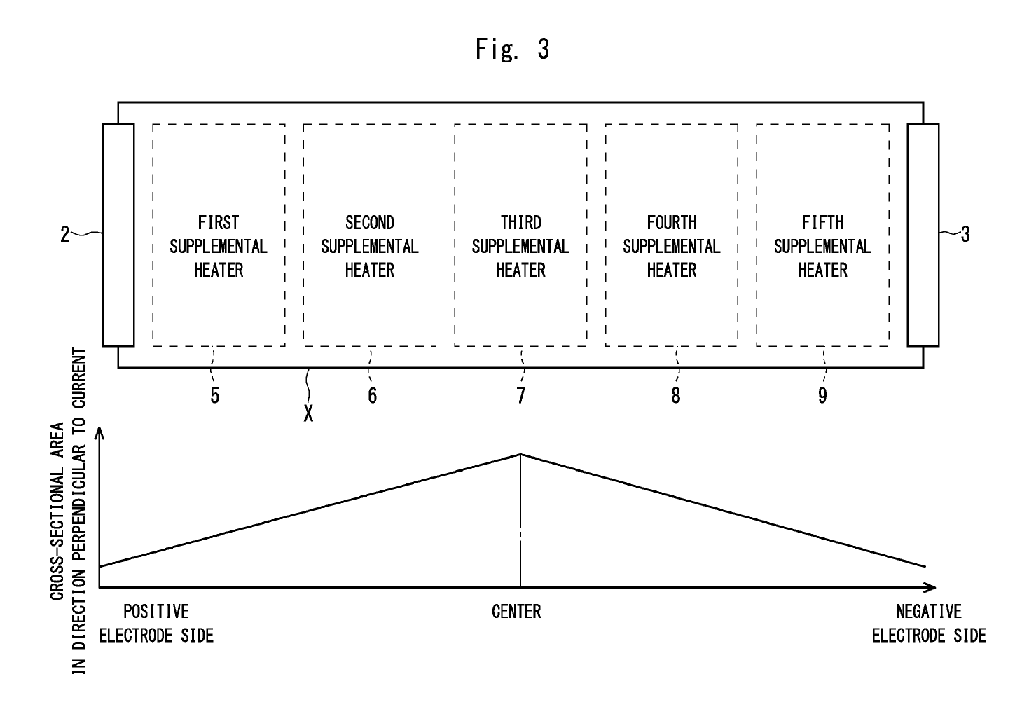

For example, assume another case where the cross-sectional area of a material to be heated gradually increases from the positive electrode side toward the center of the material to be heated and gradually decreases from the center toward the negative electrode side as shown in FIG. 3. In this case, the supplemental heating quantities for the first to fifth areas change in such a manner that the supplemental heating quantity increases from the first area on the positive electrode side toward the third area at the center and decreases from the third area at the center toward the fifth area on the negative electrode side.

((supplemental heating quantity for first area)<(supplemental heating quantity for second area)<(supplemental heating quantity for third area), (supplemental heating quantity for third area)>(supplemental heating quantity for fourth area)>(supplemental heating quantity for fifth area))

To cope with this, the control device 11 increases the heating time from the first supplemental heater 5 toward the third supplemental heater 7 since the supplemental heating quantity increases from the positive electrode side toward the center of the material to be heated. Further, the control device 11 decreases the heating time from the third supplemental heater 7 toward the fifth supplemental heater 9 since the supplemental heating quantity decreases from the center of the material to be heated toward the negative electrode side. For example, the control device 11 sets the heating time of the first supplemental heater 5 to 0 seconds, the heating time of the second supplemental heater 6 to 2 second, the heating time of the third supplemental heater 7 to 4 seconds, the heating time of the fourth supplemental heater 8 to 2 seconds, and the heating time of the fifth supplemental heater 9 to 0 seconds.

Note that although the control device 11 controls the supplemental heating for the first to fifth areas of the material to be heated X by controlling the heating time of the first to fifth supplemental heaters 5 to 9, the present invention is not limited to such a method. That is, the control device 11 may control the supplemental heating for the first to fifth areas of the material to be heated X by controlling the heating output of the first to fifth supplemental heaters 5 to 9. Alternatively, the control device 11 may control the supplemental heating for the first to fifth areas of the material to be heated X by controlling both the heating time and the heating output of the first to fifth supplemental heaters 5 to 9 at the same time.

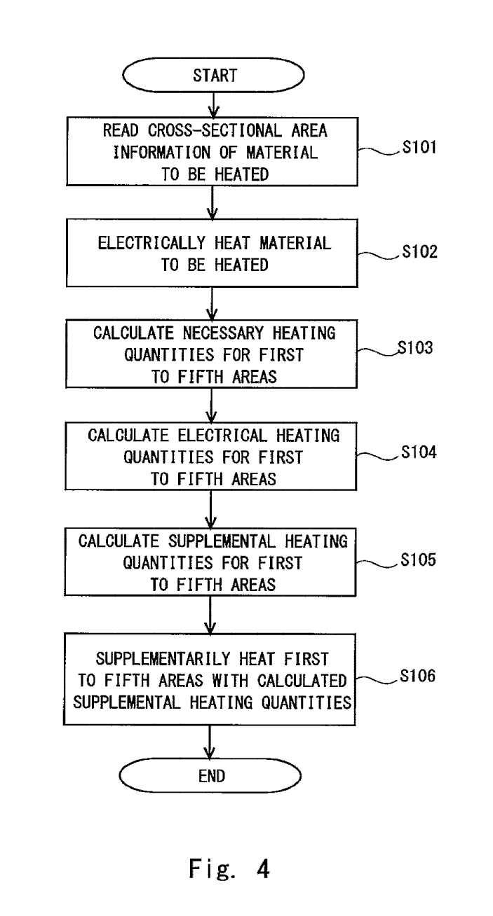

Next, an electrical heating method according to this exemplary embodiment is explained. FIG. 4 is a flowchart showing an example of a process flow of an electrical heating method according to this exemplary embodiment. The control device 11 reads cross-sectional area information on a material to be heated stored in the memory 11b (step S101).

The control device 11 starts electrical heating for the material to be heated X by controlling the power supply unit 4 and thereby supplying an electric current flowing between the positive and negative electrodes 2 and 3 (step S102).

The control device 11 calculates, for each of the first to fifth areas, a necessary heating quantity for heating that area (i.e., a respective one of the first to fifth areas) to a predefined target temperature based on the cross-sectional area information on the material to be heated X and the temperature of the material to be heated X (step S103).

The control device 11 calculates electrical heating quantities generated in the first to fifth areas by the electrical heating based on the cross-sectional area information on the material to be heated X (step S104).

The control device 11 calculates supplemental heating quantities for the first to fifth areas by subtracting the calculated electrical heating quantities from the calculated necessary heating quantities (step S105).

The control device 11 controls the first to fifth supplemental heaters 5 to 9 so as to provide the calculated supplemental heating quantities for the first to fifth areas to the first to fifth areas, respectively (step S106).

Note that the above-described steps S103 to S105 may be performed prior to the above-described step S102. Further, one of the steps S102 and S106 may be performed prior to the other step, or they may be simultaneously performed. In the above-described process, temperature differences among the first to fifth areas can be estimated from the cross-sectional area information on the material to be heated X and hence the supplemental heating quantities for the first to fifth areas can be known in advance. Therefore, the heating time of the material to be heated X can be further reduced by simultaneously performing the electrical heating and the supplemental heating.

For example, in the case of electrical heating by the related art electrical heating device, the in-surface temperature difference was 120° C. in a material to be heated made of metal having a width of 300 mm and a board-thickness of 1.2 mm. In contrast to this, for the same material to be heated, the in-surface temperature difference was reduced to 60° C. by performing electrical heating and supplemental heating by using the electrical heating device according to the above-described first exemplary embodiment. As a result, the temperature irregularity in the material to be heated could be significantly rectified and the yield was improved by 16%.

As described above, in the electrical heating device 1 according to this exemplary embodiment, the control device 11 calculates a necessary heating quantity necessary for heating the first to fifth areas to a predefined target temperature and electrical heating quantities generated in the first to fifth areas by the electrical heating based on the cross-sectional area information on the material to be heated X and temperature information on the material to be heated X. Then, the control device 11 calculates supplemental heating quantities for the first to fifth areas by subtracting the calculated electrical heating quantities from the calculated necessary heating quantities. The control device 11 controls, in addition to the control of the electrical heating, the first to fifth supplemental heaters 5 to 9 so that the first to fifth areas are supplementarily heated based on the calculated supplemental heating quantities for the first to fifth areas.

In this way, for each of the first to fifth areas of the material to be heated X, a heat quantity by which the quantity of the heat generated by the electrical heating alone is insufficient to raise the temperature of that area (i.e., a respective one of the first to fifth areas) to the target temperature is calculated by using the cross-sectional area information on the material to be heated X. Then, the calculated heat quantities can be provided to the first to fifth areas in a concentrated manner by using the first to fifth supplemental heaters 5 to 9. That is, it is possible to reduce the heating time for the material to be heated X by performing necessary supplemental heating simultaneously with the electrical heating with consideration given to the cross-sectional area information on the material to be heated X without moving the electrodes.

Note that the present invention is not limited to the above-described exemplary embodiment, and it can be modified as appropriate without departing from the sprit and scope of the present invention.

In the above-described exemplary embodiment, the control device 11 may control the first to fifth supplemental heaters 5 to 9 so that only some of the first to fifth areas for which the calculated supplemental heating quantity is equal to or larger than a predetermined threshold are supplementarily heated with the calculated supplemental heating quantities. In such a case, for example, the temperature irregularity of the material to be heated can be rectified by supplementarily heating only a local low-temperature area(s) for which the calculated supplemental heating quantity is equal to or larger than the predetermined threshold. Therefore, since the supplemental heating needs to be performed only for a part(s) of the material to be heated X, the heating time for the material to be heated X can be further reduced. Note that the predetermined threshold is changed as appropriate according to the required processing accuracy and the heating time for the material to be heated X. For example, as the predetermined threshold is increased, the heating time for the material to be heated X can be further reduced, though the processing accuracy for the material to be heated X is lowered.

In the above-described exemplary embodiment, the control device 11 may stop the electrical heating by the power supply unit 4 and the supplemental heating by the first to fifth supplemental heaters 5 to 9 when the temperature of the material to be heated X detected by the temperature sensor 10 reaches the target temperature. Note that the target temperature is, for example, set in the memory 11b in advance with consideration given to the characteristic of the material to be heated X. Further, the temperature sensor 10 may detect the temperature of each of the first to fifth areas of the material to be heated X or detect the temperature of a predetermined area(s) (such as an area having a small cross-sectional area). In this way, both of excessive heating by the electrical heating and excessive heating by the supplemental heating by the first to fifth supplemental heaters 5 to 9 can be reliably prevented.

In the above-described exemplary embodiment, the control device 11 may calculate a maximum value Smax for the cross-sectional area among the cross-sectional areas of the first to fifth areas (such as average cross-sectional areas of respective areas or cross-sectional areas at the centers of respective areas) and supplementarily heat the first to fifth areas based on differences between this maximum value Smax and the cross-sectional areas S of the first to fifth areas.

The control device 11 calculates the maximum value Smax for the cross-sectional area among the cross-sectional areas of the first to fifth areas based on the cross-sectional area information on the material to be heated. The control device 11 calculates each of the differences (Samx−S) between the calculated maximum value for the cross-sectional area and the cross-sectional areas S of the first to fifth areas. The control device 11 calculates supplemental heating quantities for the first to fifth areas based on the calculated cross-sectional area differences. Note that as the cross-sectional area differences increase, the supplemental heating quantities increase and hence the heating times of the first to fifth supplemental heaters 5 to 9 increase.

For example, as shown below, the heating times of the first to fifth supplemental heaters 5 to 9 are determined by using first to fourth thresholds (first threshold<second threshold<third threshold<fourth threshold).

When the calculated difference for one of the first to fifth areas is less than the first threshold A, the control device 11 sets the heating time of one of the first to fifth supplemental heaters 5 to 9 corresponding to that area to 0 seconds. Note that, for example, a value equivalent to 3% of the maximum value for the cross-sectional area of the material to be heated is set as the first threshold A.

When the calculated difference for one of the first to fifth areas is less than the second threshold B, the control device 11 sets the heating time of one of the first to fifth supplemental heaters 5 to 9 corresponding to that area to 1 second. Note that, for example, a value equivalent to 6% of the maximum value for the cross-sectional area of the material to be heated is set as the second threshold B.

When the calculated difference for one of the first to fifth areas is less than the third threshold C, the control device 11 sets the heating time of one of the first to fifth supplemental heaters 5 to 9 corresponding to that area to 2 second. Note that, for example, a value equivalent to 9% of the maximum value for the cross-sectional area of the material to be heated is set as the third threshold C.

When the calculated difference for one of the first to fifth areas is less than the fourth threshold D, the control device 11 sets the heating time of one of the first to fifth supplemental heaters 5 to 9 corresponding to that area to 3 second. Note that, for example, a value equivalent to 12% of the maximum value for the cross-sectional area of the material to be heated is set as the fourth threshold D.

When the calculated difference for one of the first to fifth areas is equal to or greater than the fourth threshold D, the control device 11 sets the heating time of one of the first to fifth supplemental heaters 5 to 9 corresponding to that area to 4 second.

Note that, for example, a relation between the above-described thresholds and the heating times is defined so that as the threshold increases, the heating time increases. Further, the relation is experimentally obtained and stored in the memory 11b in advance. Further, the number of thresholds can be arbitrarily determined. It is possible to perform the supplemental heating more precisely by increasing the number of thresholds.

The control device 11 controls the first to fifth supplemental heaters 5 to 9 with the set heating times for the respective areas.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An electrical heating device that electrically heats a material to be heated by bringing a plurality of electrodes into contact with the material to be heated with a predetermined distance between the electrodes and supplying an electric current flowing between the electrodes, comprising:
supplemental heating means for supplementarily heating each of a plurality of areas defined in advance in the material to be heated; and
control means for controlling the electrical heating and the supplemental heating for the material to be heated, wherein
a supplemental heating quantity for each of the plurality of areas is obtained by calculating a necessary heating quantity for heating each of the plurality of areas to a predefined target temperature and an electrical heating quantity generated in each of the plurality of areas by the electrical heating based on cross-sectional area information on the material to be heated and temperature information on the material to be heated and subtracting the calculated electrical heating quantity from the calculated necessary heating quantity, and
the control means controls, in addition to the control of the electrical heating, the supplemental heating means so that each of the plurality of areas is supplementarily heated based on the obtained supplemental heating quantity for each of the plurality of areas.

2. An electrical heating method for electrically heating a material to be heated by bringing a plurality of electrodes into contact with the material to be heated with a predetermined distance between the electrodes and supplying an electric current flowing between the electrodes, comprising:
calculating a necessary heating quantity for heating a plurality of areas defined in advance in the material to be heated to a predefined target temperature and an electrical heating quantity generated in each of the plurality of areas by the electrical heating based on cross-sectional area information on the material to be heated and temperature information on the material to be heated;
calculating a supplemental heating quantity for each of the plurality of areas by subtracting the calculated electrical heating quantity from the calculated necessary heating quantity; and
controlling, in addition to the control of the electrical heating, supplemental heating for each of the plurality of areas based on the calculated supplemental heating quantity for each of the plurality of areas.

3. An electrical heating device that electrically heats a material to be heated by bringing a plurality of electrodes into contact with the material to be heated with a predetermined distance between the electrodes and supplying an electric current flowing between the electrodes, comprising:
supplemental heating unit that supplementarily heats each of a plurality of areas defined in advance in the material to be heated; and
control unit that controls the electrical heating and the supplemental heating for the material to be heated, wherein
a supplemental heating quantity for each of the plurality of areas is obtained by calculating a necessary heating quantity for heating each of the plurality of areas to a predefined target temperature and an electrical heating quantity generated in each of the plurality of areas by the electrical heating based on cross-sectional area information on the material to be heated and temperature information on the material to be heated and subtracting the calculated electrical heating quantity from the calculated necessary heating quantity, and
the control unit controls, in addition to the control of the electrical heating, the supplemental heating unit so that each of the plurality of areas is supplementarily heated based on the obtained supplemental heating quantity for each of the plurality of areas.
